(19) United States
(12) Patent Application Publication
(10) Pub. No.: US 2025/0267034 A1
(43) Pub. Date: Aug. 21, 2025

(54) IDENTIFIER FILTERING

(71) Applicant: Infineon Technologies AG, Neubiberg (DE)

(72) Inventors: Florin-Andrei GINDAC, Bucharest (RO); Andrei Valentin DANCHIV, Bucuresti (RO); Andreas JANSEN, Murnau (DE)

(21) Appl. No.: 19/056,839

(22) Filed: Feb. 19, 2025

(30) Foreign Application Priority Data
Feb. 21, 2024 (DE) 102024201582.2

(51) Int. Cl. H04L 12/40

(52) U.S. Cl. CPC H04L 12/40104; H04L 12/40013; H04L 2012/40215

(57) ABSTRACT

A controller node (112) is presented. The controller node (112) is configured for being connected to at least one further controller node (112) via a communication interface (114) transferring signals between a plurality of controller nodes (112). The signals comprise identifiers. The controller node (112) comprises an identifier filter (120). The identifier filter (120) is a hardware filter device. The identifier filter (120) is configured for receiving an identifier sent by a further controller node (112), deciding if the identifier is relevant for the controller node (112) and, if the identifier is relevant for the controller node (112), performing a task relating to the identifier. Further, a method for filtering identifiers, a controller node network (110) and a use of the controller node (112), the method for filtering identifiers or the controller node network (110) are presented.

### TECHNICAL FIELD

The present disclosure relates to a controller node, a method for filtering identifiers, a controller node network and a use thereof.

### BACKGROUND

Controller nodes can be used for controlling a variety of different applications, e.g. in the automotive field, such as motor control electronics or others. Typically, a plurality of controller nodes are connected to each other within a network for controlling larger systems, e.g. an entire vehicle or a larger part thereof. As an example, each controller node may control a different application in a vehicle and the controller node network may control a larger part of the vehicle or even the entire vehicle. In an automotive application, a local interconnected network (LIN) is typically used for such purpose. The local interconnected network may further usually complement a controller area network (CAN). As an example, a master or commander of a local interconnected network may also be connected to a superordinate controller area network.

For communication, data frames exchanged between the controller nodes within the controller node network may comprise headers and responses. The header may signal an intention of a new communication. It may further calibrate receiving frequencies and prepare receiving controller nodes for a response. The controller nodes may receive the header and decode its meaning, which may specifically be carried by an identifier being part of the header. An identifier may describe a response in terms of data length, meaning of the message, and direction of communication. Each controller node in a controller node network may have several identifiers allocated to it, e.g. depending on the function of the controller node within the controller node network. As an example, a controller node may be configured for controlling a specific application, e.g. a motor, and identifiers referring to controlling that motor may be allocated to it.

Each received identifier must typically be evaluated by the controller nodes within the controller node network in order to determine whether it is of interest for that specific controller node or not. Many identifiers may not be relevant for a specific controller node, but may rather address another controller node within the controller node network. This evaluation process is usually performed by software in an interrupt request handler. Thus, each interrupt request typically increases the processor load or in other words the amount of computation work performed by software. This is typically also the case for identifiers, which are irrelevant for the respective controller node, but nevertheless issue such an interrupt request. Thus, there is specifically a need for reducing this processor load.

### SUMMARY

In a first aspect of the present disclosure, a controller node is presented. The controller node is configured for being connected to at least one further controller node via a communication interface transferring signals between a plurality of controller nodes. The signals comprise identifiers. The controller node comprises an identifier filter. The identifier filter is a hardware filter device. The identifier filter is configured for receiving an identifier sent by a further controller node, deciding if the identifier is relevant for the controller node and, if the identifier is relevant for the controller node, performing a task relating to the identifier.

In a further aspect of the present disclosure, a method for filtering identifiers is presented. The method comprises:
a) receiving an identifier at an identifier filter of a controller node, wherein the identifier filter is a hardware filter device;
b) deciding if the identifier is relevant for the controller node by using the identifier filter; and
c) if the identifier is relevant for the controller node, performing a task relating to the identifier.

In a further aspect of the present disclosure, a controller node network is presented. The controller node network comprises a plurality of controller nodes. The controller node network further comprises a communication interface connecting the controller nodes. The communication interface is configured for transferring signals between the controller nodes. The signals comprise identifiers. At least one controller node comprises an identifier filter. The identifier filter is a hardware filter device. The identifier filter is configured for receiving an identifier sent by a further controller node, deciding if the identifier is relevant for the controller node and, if the identifier is relevant for the controller node, performing a task relating to the identifier.

In a further aspect, a use of the controller node and/or the method for filtering identifiers and/or the controller node network is presented for an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates an example of a controller node network and controller nodes according to the present disclosure;

FIG. 2 schematically illustrates an example of an identifier filter according to the present disclosure;

FIG. 3 schematically illustrates a further example of a controller node network and controller nodes according to the present disclosure; and

FIG. 4 illustrates a flow chart of an example of a method for filtering identifiers according to the present disclosure.

### DETAILED DESCRIPTION

The examples described herein provide considerable advantages over the prior art. The controller nodes according to the present disclosure comprise identifier filters, which are hardware filter devices. Thus, a hardware control mechanism may restrict issuing interrupt requests which would increase processor load. The implementation of the identifier filter in hardware can reduce processor load and responsiveness. Further, it can simplify the software architecture. Having common subtasks executed by hardware in the background can provide increased responsiveness and prevention of data loss.

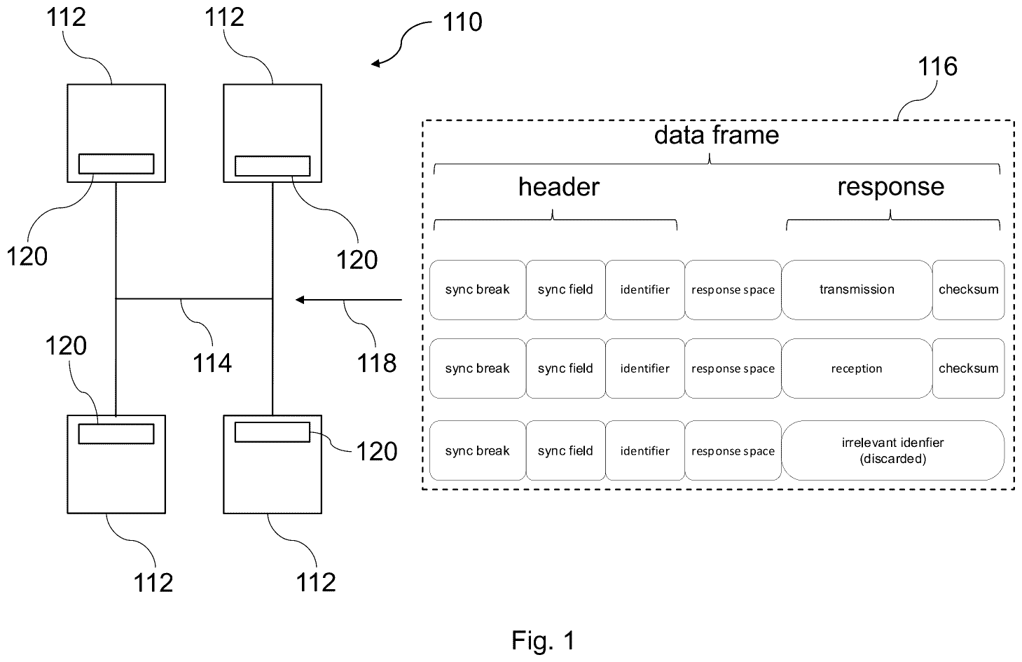

FIG. 1 schematically illustrates an example of a controller node network 110. The controller node network 110 comprises a plurality of controller nodes 112. Although FIG. 1 only explicitly shows four controller nodes 112, the controller node network 110 may of course in principle comprise an arbitrary number of controller nodes 112. The controller nodes 112 may all be of the same hierarchy or may at least partially be of a different hierarchy. Thus, at least one of the controller nodes 112 may be a master controller node and at least one of the controller nodes 112 may be a slave controller node. Synonymously to the terms master and slave, the terms commander and responder may be used throughout the present disclosure. Thus, at least one controller node 112 may be configured for controlling at least one further controller node 112. Further, at least one controller node 112 may be configured for controlling an application, specifically an automotive application, e.g. a motor. At least one of the controller nodes 112 may be or may comprise a microcontroller. However, as indicated, all controller nodes 112 may in principle also be of the same hierarchy.

The controller node network 110 further comprises a communication interface 114. The communication interface 114 connects the controller nodes 112. Thus, the controller node network 110 may be an interconnected group of controller nodes 112. The communication interface 114 may be or may comprise a bus, specifically a serial bus. The controller node network 110 may be a broadcast network, specifically a broadcast serial network. The communication interface 114 may be or may comprise at least one signal line, specifically a data line. Additionally, the communication interface 114 may comprise a clock line. However, the communication interface 114 may also be realized without a separate clock line. The communication interface 114 is configured for transferring signals between the controller nodes 112. The signals comprise identifiers. The signals may also comprise further components. An exemplary structure of the signals transferred via the communication interface 114 is depicted within dashed box 116 as indicated by arrow 118. The signals may specifically be or may comprise data frames or at least parts thereof. A data frame may comprise a header, a configurable response space and a response. Thus, the header and the response may be separated by the response space.

The header may initiate a communication. A controller node 112 may send the header to the further controller nodes 112 via the communication interface 114, e.g. when commanding a task to a further controller node 112. The further controller nodes 112 may all receive the header. The header may comprise a synchronization break (sync break), a synchronization field (sync field) and the identifier. The synchronization break may be an indication that the controller node 112 starts to send data. The synchronization field may indicate the frequency used for sending the data. The identifier may indicate the kind of task which is to be performed or which one of the controller nodes 112 is addressed for performing the task. The controller nodes 112 may receive and decode the identifier. Thus, each controller node 112 may evaluate whether the identifier is relevant for it or not. If a controller node 112 determines that the identifier is relevant for it, it may send a corresponding response via the communication interface 114. The response may be or may comprise a transmission, e.g. of requested data. Additionally or alternatively, the response may be or may comprise a reception, such as when rewriting a configuration of the controller node 112. Further, the response may comprise a checksum as a verification measure.

The identifier may specifically be a protected identifier. The protected identifier may comprise at least one protection measure, specifically at least one verification measure. Thus, the protected identifier may comprise a parity indicator, specifically at least one parity bit, more specifically two parity bits. As an example, the protected identifier may overall comprise ten bits, i.e. one start bit, one stop bit, two parity bits and six identifier bits. The six identifier bits may result in overall 64 available identifiers which may be sent via the communication interface 114. One available identifier may be reserved for a diagnose request, one may be reserved for a diagnose response and two may be reserved for future use leaving overall 60 available identifiers. Thus, 60 identifiers may be available overall for communication in the controller node network 110. However, for each controller node 112, only a portion of the available identifiers may be relevant. Thus, each controller node 112 may have to filter out the identifiers which are irrelevant for it. Instead of using an interrupt request handler implemented in software, this feature can also be implemented in hardware reducing processor load.

At least one controller node 112 comprises an identifier filter 120. The identifier filter 120 is a hardware filter device. The identifier filter 120 is configured for receiving an identifier sent by a further controller node 112. The identifier filter 120 is further configured for deciding if the identifier is relevant for the controller node 112. The identifier filter 120 is configured for, if the identifier is relevant for the controller node 112, performing a task relating to the identifier. An identifier which is relevant for the controller node 112 may generally relate to a task the controller node 112 is configured to perform, e.g. controlling a specific application such as a specific motor. In other words, when the controller node 112 can perform a task, a corresponding identifier may be relevant for it. Contrarily, when the controller node 112 cannot perform the task, the corresponding identifier may be irrelevant for it. The identifier filter 120 may specifically be configured for gating identifiers which are irrelevant for the controller node 112 from issuing an interrupt request. Such an interrupt request may have to be handled by an interrupt request handler increasing processor load. Thus, by discarding irrelevant identifiers or in other words by preventing them from issuing an interrupt request, processor load may be reduced. Thus, the identifier filter 120 may be configured for filtering out identifiers which are irrelevant for the controller node 112. An identifier which is irrelevant for the controller node 112 may relate to a task the controller node 112 is not configured to perform.

Said tasks may generally comprise at least one of: an operation task; an output task; a diagnostics task; a configuration task. The operation task may comprise at least one of: a switching operation; a regulation operation; a measurement operation. As an example, the task may be to switch on or switch off a motor or to measure motor data, e.g. temperature or pressure or velocity. Accordingly, the output task may comprise an output of measurement data or control data. The measurement data may be for instance temperature data or pressure data or velocity data. The diagnostic task may comprise a self-check of the controller node 112 or a check of the controlled application. The configuration task may comprise changing settings of the controller node 112 or of the controlled application. As already indicated, the controller nodes 112 may specifically be used for controlling automotive applications. However, other options besides to those which are exemplarily mentioned here may of course also generally be feasible.

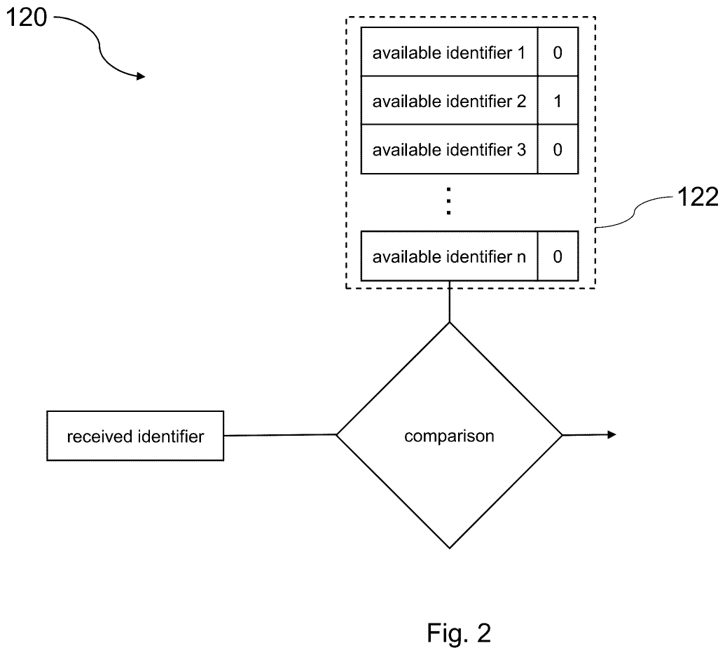

FIG. 2 schematically illustrates an example of an identifier filter 120. The identifier filter 120 may be a part of a controller node 112 of the controller node network 110 depicted in FIG. 1. The identifier filter 120 may comprise at least one identifier register 122. The identifier register 122 may be configured for indicating which identifiers are relevant for the respective controller node 112. Thus, the identifier register 122 may be or may comprise a lookup table or a list, specifically an enable list, wherein the lookup table or the list comprise available identifiers and a corresponding relevance indication for each available identifier. The available identifiers may be identifiers which are generally used in the controller node network 110. As already indicated above, overall 60 identifiers may for instance be available in the controller node network. Thus, the identifier register 122 may comprise 60 entries for 60 available identifiers in the controller node network. Generally, an arbitrary number n of available identifiers may of course be possible.

As outlined, each available identifier may be marked by a relevance indication. The relevance indication may generally be a tag specifying whether the generally available identifier is relevant for the controller node 112 comprising the identifier filter 120. In particular, the relevance indication may be or may comprise at least one enable bit. More specifically, the relevance indication may be a 0 as an enable bit, which may indicate that the corresponding available identifier is irrelevant for the controller node 112, or a 1 as an enable bit, which may indicate that the corresponding available identifier is relevant for the controller node 112. Thus, as an example and as shown in FIG. 2, a first generally available identifier may be tagged with a 0 meaning that this available identifier may be irrelevant for the controller node 112. A second available identifier may be tagged with a 1 meaning that this available identifier may be relevant for the controller node 112 and so forth. The enable bits may be stored in a memory device, specifically in flip-flops. Thus, as an example, also considering the available identifier reserved for a diagnose request, the available identifier reserved for a diagnose response and two available identifiers reserved for future use additionally to the 60 generally available identifiers, the identifier filter may comprise 64 flip-flops and may thus also be comparably area sensitive. Specifically, the identifier register 122 may reduce chip area compared to storing an individual list of relevant identifiers for each controller node 112.

Regarding the workflow, the controller node 112 and specifically the identifier filter 120 may receive an identifier, e.g. after detecting a synchronization break and a synchronization field on the communication interface 114. Subsequently, the identifier filter 120 may compare the received identifier with the entries in the identifier register 122. As said, an identifier may for instance in principle comprise ten bits, i.e. one start bit, one stop bit, two parity bits and six identifier bits. The identifier filter 120 may specifically use the six identifier bits for the comparison. The received identifier may be a generally available identifier in the controller node network 110. However, the received identifier may not necessarily be relevant for the respective controller node 112, but for another controller node 112 of the controller node network 110. In such case, it should be filtered out by the identifier filter without issuing an interrupt request which would increase processor load. In case the received identifier is relevant for the controller node 112, a corresponding enable bit should be set to 1 in the identifier register, such that the received identifier is not discarded. Thus, when an outcome of the comparison between the received identifier and the identifier register 122 indicates that the corresponding enable bit is set to 1 and that the received identifier is accordingly relevant for the controller node 112, the controller node 112 may perform the task relating to the identifier, e.g. switch on or switch off an application or output data.

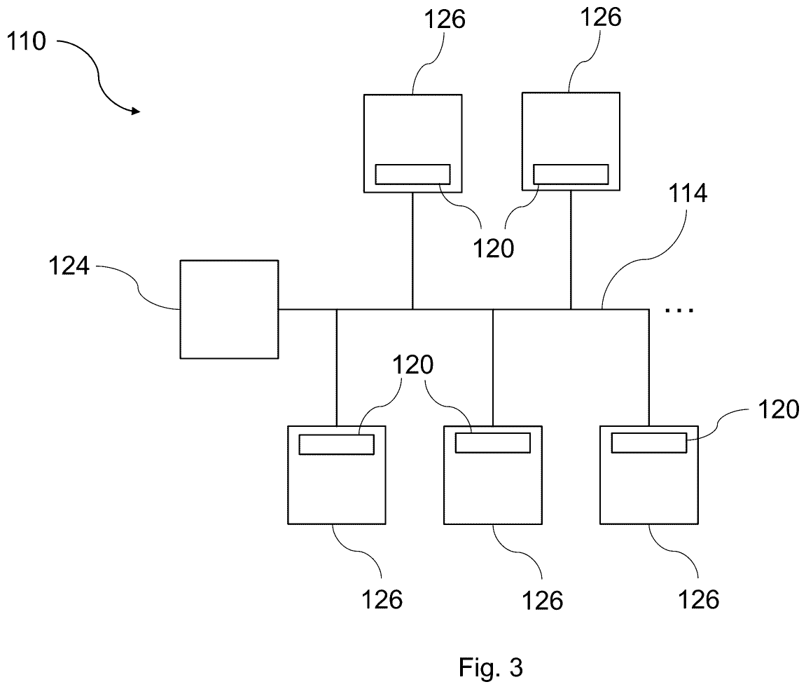

FIG. 3 schematically illustrates a further example of a controller node network 110. At least to a large extent, the controller node network 110 depicted in FIG. 3 corresponds to the controller node network 110 depicted in FIG. 1. Thus, for the description of the controller node network 110 in FIG. 3 reference may be made to the description of the controller node network 110 depicted in FIG. 1 at least to a large extent. FIG. 3 specifically indicates that the controller node network 110 may comprise at least one master controller node 312 and at least one slave controller node 126. More specifically, the controller node network 110 may comprise a master controller node 124 and a plurality of slave controller nodes 126, in particular up to 15 slave controller nodes 126. Although FIG. 3 only explicitly shows five slave controller nodes 126, the controller node network 110 may of course in principle comprise an arbitrary number of slave controller nodes 126. Specifically, at least the slave controller nodes 126 depicted in FIG. 3 may correspond to the controller nodes 112 depicted in FIG. 1. More specifically, the slave controller nodes 126 or at least a some of them may comprise identifier filters 120. Thus, the slave controller nodes 126 may be configured for filtering out identifiers, which are irrelevant to them, by using a hardware mechanism. The identifiers may specifically be sent by the master controller node 124.

The master controller node 124 may be master for all slave controller nodes 126. However, a multi-master-arrangement may in principle of course also be conceivable. The controller node network 110 may specifically be a local interconnect network (LIN). As said, the controller node network 110 comprises a communication interface 316, specifically a serial bus. The communication interface 114 may connect the master controller node 124 and the slave controller nodes 126. The master controller node 124 may further be connected or at least configured for being connected to a controller area network (CAN) or another back-bone-network. Thus, more generally, the controller node network 110 may be one of a plurality of networks, specifically lower hierarchy networks, connected by a back-bone-network. Specifically, the controller node network 110 may be one of a plurality of a local interconnect networks in a vehicle. There, the controller node network 110 may be used for interconnecting applications in a part of the vehicle, e.g. motors or sensors in a door or in a seat. The controller node network 110 or at least the master controller node 124 may then also be part of a higher hierarchy controller area network interconnecting the entire vehicle or at least a larger part of the vehicle. Generally, the devices and methods presented herein may specifically be used in an automotive application, such as for controlling an application in a vehicle, e.g. a motor. Other uses may however of course also be conceivable.

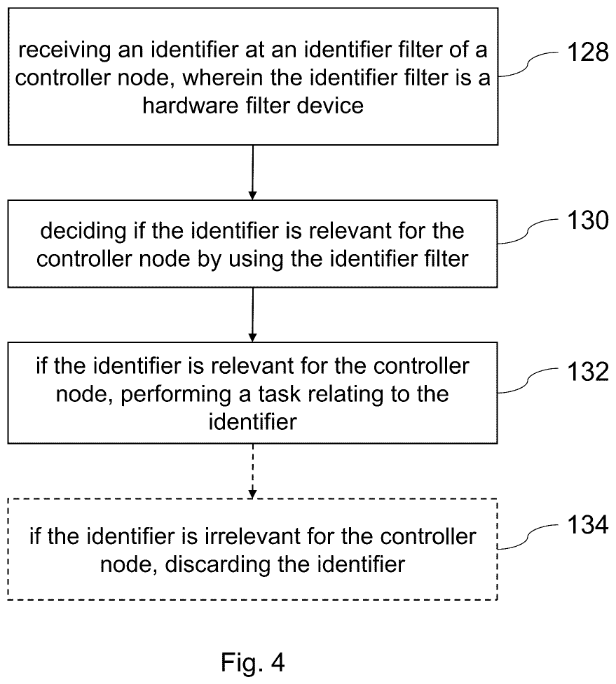

FIG. 4 illustrates a flow chart of an example of a method for filtering identifiers. The method comprises the following steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion.
a) (denoted by reference numeral 128) receiving an identifier at an identifier filter 120 of a controller node 112, wherein the identifier filter 120 is a hardware filter device;
b) (denoted by reference numeral 130) deciding if the identifier is relevant for the controller node 112 by using the identifier filter 120;
c) (denoted by reference numeral 132) if the identifier is relevant for the controller node 112, performing a task relating to the identifier; and optionally
d) (denoted by reference numeral 134) if the identifier is irrelevant for the controller node 112, discarding the identifier.

In addition to the above described examples, the following examples are disclosed herein:

Example 1: A controller node configured for being connected to at least one further controller node via a communication interface transferring signals between a plurality of controller nodes, wherein the signals comprise identifiers, wherein the controller node comprises an identifier filter, wherein the identifier filter is a hardware filter device and is configured for:
receiving an identifier sent by a further controller node;
deciding if the identifier is relevant for the controller node; and.
if the identifier is relevant for the controller node, performing a task relating to the identifier.

Example 2: The controller node according to the preceding Example, wherein the task comprises at least one of: an operation task; an output task; a diagnostics task; a configuration task.

Example 3: The controller node according to any one of the preceding Examples, wherein the task is an operation task comprising at least one of a switching operation; a regulation operation; a measurement operation.

Example 4: The controller node according to any one of the preceding Examples, wherein the task is an output task comprising an output of measurement data selected from the group consisting of: temperature data; pressure data; velocity data.

Example 5: The controller node according to any one of the preceding Examples, wherein the controller node is configured for controlling at least one application, specifically an automotive application, more specifically a motor.

Example 6: The controller node according to any one of the preceding Examples, wherein an identifier which is relevant for the controller node relates to a task the controller node is configured to perform.

Example 7: The controller node according to any one of the preceding Examples, wherein the identifier filter is configured for gating identifiers which are irrelevant for the controller node from issuing an interrupt request.

Example 8: The controller node according to any one of the preceding Examples, wherein the identifier filter is configured for filtering out identifiers which are irrelevant for the controller node.

Example 9: The controller node according to any one of the preceding Examples, wherein the controller node is configured for acting as a slave controller node with respect to the further controller node.

Example 10: The controller node according to any one of the preceding Examples, wherein the controller node is configured for being a part of a controller node network comprising a plurality of controller nodes, specifically at least one master controller node and at least one slave controller node.

Example 11: The controller node according to any one of the preceding Examples, wherein the controller node is configured for being a part of a controller node network comprising a plurality of controller nodes, specifically at least one master controller node and at least one slave controller node.

Example 12: The controller node according to the preceding Example, wherein the controller node network is a broadcast serial network.

Example 13: The controller node according to any one of the two preceding Examples, wherein the controller node network is a local interconnect network (LIN).

Example 14: The controller node according to any one of the preceding Examples, wherein the identifier is a part of a header.

Example 15: The controller node according to the preceding Example, wherein the header further comprises a synchronization break and a synchronization field.

Example 16: The controller node according to any one of the two preceding Examples, wherein the header is part of a data frame.

Example 17: The controller node according to any one of the three preceding Examples, wherein the data frame further comprises a response.

Example 18: The controller node according to any one of the four preceding Examples, wherein the data frame further comprises a configurable response space separating the header and the response.

Example 19: The controller node according to any one of the preceding Examples, wherein the signals transferred via the communication interface comprise data frames or at least parts thereof.

Example 20: The controller node according to any one of the preceding Examples, wherein the identifier is a protected identifier, wherein the protected identifier comprises at least one protection measure, specifically at least one verification measure.

Example 21: The controller node according to the preceding Example, wherein the protected identifier comprises a parity indicator, specifically at least one parity bit, more specifically two parity bits.

Example 22: The controller node according to any one of the preceding Examples, wherein the identifier filter comprises an identifier register indicating which identifiers are relevant for the controller node.

Example 23: The controller node according to the preceding Example, wherein the identifier register is a lookup table comprising available identifiers and a corresponding relevance indication for each available identifier.

Example 24: The controller node according to the preceding Example, wherein the relevance indication comprises an enable bit for each available identifier.

Example 25: The controller node according to the preceding Example, wherein the identifier register comprises at least one memory device, specifically a flip-flop, wherein the enable bit is stored by using the memory device.

Example 26: The controller node according to any one of the preceding Examples, wherein the controller node is a microprocessor.

Example 27: A method for filtering identifiers, comprising:
a) receiving an identifier at an identifier filter of a controller node, wherein the identifier filter is a hardware filter device;
b) deciding if the identifier is relevant for the controller node by using the identifier filter; and
c) if the identifier is relevant for the controller node, performing a task relating to the identifier.

Example 28: The method according to the preceding Example, wherein the controller node is a controller node according to any one of the preceding Examples referring to a controller node.

Example 29: The method according to any one of the preceding method Examples, further comprising:
d) if the identifier is irrelevant for the controller node, discarding the identifier.

Example 30: A controller node network comprising:
a plurality of controller nodes; and
a communication interface connecting the controller nodes, wherein the communication interface is configured for transferring signals between the controller nodes, wherein the signals comprise identifiers,
   wherein at least one controller node comprises an identifier filter, wherein the identifier filter is a hardware filter device and is configured for:
receiving an identifier sent by a further controller node;
deciding if the identifier is relevant for the controller node; and.
if the identifier is relevant for the controller node, performing a task relating to the identifier.

Example 31: The controller node network according to the preceding Example, wherein the controller node comprising the identifier filter is a controller node according to any one of the preceding Examples referring to a controller node.

Example 32: The controller node network according to any one of the preceding Examples referring to a controller node network, wherein the controller node network is a broadcast serial network.

Example 33: The controller node network according to any one of the preceding Examples referring to a controller node network, wherein the controller node network is a local interconnect network (LIN).

Example 34: The controller node network according to any one of the preceding Examples referring to a controller node network, wherein the controller node comprising an identifier filter is a slave controller node with respect to the further controller node sending the identifier.

Example 35: The controller node network according to any one of the preceding Examples referring to a controller node network, wherein the controller node network comprises one controller node acting as a master controller node with respect to all further controller nodes of the controller node network.

Example 36: The controller node network according to the preceding Example, wherein the controller node acting as a master controller node with respect to all further controller nodes is further connected to a controller area network (CAN).

Example 37: The controller node network according to any one of the preceding Examples referring to a controller node network, wherein the communication interface comprises a bus, specifically a serial bus.

Example 38: The controller node network according to any one of the preceding Examples referring to a controller node network, wherein at least one of the controller nodes is a microcontroller.

Example 39: A use for an automotive application of at least one of a controller node according to any one of the preceding Examples referring to a controller node, a method for filtering identifiers according to any one of the preceding method Examples and a controller node network according to any one of the preceding Examples referring to a controller node network.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. A controller node configured for being connected to at least one further controller node via a communication interface transferring signals between a plurality of controller nodes, wherein the signals comprise identifiers, wherein the controller node comprises an identifier filter, wherein the identifier filter is a hardware filter device and is configured for:
receiving an identifier sent by a further controller node;
deciding if the identifier is relevant for the controller node; and
if the identifier is relevant for the controller node, performing a task relating to the identifier.

2. The controller node of claim 1, wherein the task comprises at least one of: an operation task; an output task; a diagnostics task; a configuration task.

3. The controller node of claim 1, wherein an identifier which is relevant for the controller node relates to a task the controller node is configured to perform.

4. The controller node of claim 1, wherein the identifier filter is configured for gating identifiers which are irrelevant for the controller node from issuing an interrupt request.

5. The controller node of claim 1, wherein the controller node is configured for acting as a slave controller node with respect to the further controller node.

6. The controller node of claim 1, wherein the controller node is configured for being a part of a controller node network comprising a plurality of controller nodes, specifically at least one master controller node and at least one slave controller node.

7. The controller node of claim 1, wherein the identifier is a part of a header, wherein the header further comprises a synchronization break and a synchronization field, wherein the header is part of a data frame, wherein the data frame further comprises a response, wherein the data frame further comprises a configurable response space separating the header and the response.

8. The controller node of claim 1, wherein the identifier is a protected identifier, wherein the protected identifier comprises at least one protection measure, specifically at least one verification measure.

9. The controller node of claim 1, wherein the protected identifier comprises a parity indicator, specifically at least one parity bit, more specifically two parity bits.

10. The controller node of claim 1, wherein the identifier filter comprises an identifier register indicating which identifiers are relevant for the controller node.

11. The controller node of claim 1, wherein the identifier register is a lookup table comprising available identifiers and a corresponding relevance indication for each available identifier.

12. The controller node of claim 1, wherein the relevance indication comprises an enable bit for each available identifier.

13. A method for filtering identifiers, comprising:
a) receiving an identifier at an identifier filter of a controller node, wherein the identifier filter is a hardware filter device;
b) deciding if the identifier is relevant for the controller node by using the identifier filter; and
c) if the identifier is relevant for the controller node, performing a task relating to the identifier.

14. A controller node network comprising:
a plurality of controller nodes; and
a communication interface connecting the controller nodes, wherein the communication interface is configured for transferring signals between the controller nodes, wherein the signals comprise identifiers,
wherein at least one controller node comprises an identifier filter, wherein the identifier filter is a hardware filter device and is configured for:
receiving an identifier sent by a further controller node;
deciding if the identifier is relevant for the controller node; and
if the identifier is relevant for the controller node, performing a task relating to the identifier.

15. The controller node network of claim 14, wherein the controller node network is a local interconnect network (LIN).

16. The controller node network of claim 14 wherein the controller node network comprises one controller node acting as a master controller node with respect to all further controller nodes of the controller node network.

17. The controller node network of claim 14, wherein the controller node acting as a master controller node with respect to all further controller nodes is further connected to a controller area network (CAN).

18. The controller node network of claim 14, wherein the communication interface comprises a bus, specifically a serial bus.

19. The controller node network of claim 14, wherein at least one of the controller nodes is a microcontroller.
